(19) United States
(12) Patent Application Publication
(10) Pub. No.: US 2026/0045386 A1
(43) Pub. Date: Feb. 12, 2026

(54) FLAT-SHAPED BUNDLING MEMBER AND WIRE HARNESS

(71) Applicant: YAZAKI CORPORATION, Tokyo (JP)

(72) Inventors: Takashi UEMBYU, Susono-shi (JP); Yuki Tosaya, Susono-shi (JP); Shodai Suzuki, Susono-shi (JP); Makoto Kambe, Susono-shi (JP)

(73) Assignee: YAZAKI CORPORATION, Tokyo (JP)

(21) Appl. No.: 19/265,201

(22) Filed: Jul. 10, 2025

(30) Foreign Application Priority Data
Aug. 9, 2024 (JP) 2024-133911

(51) Int. Cl. H01B 7/08; B60R 16/02; H01B 7/00

(52) U.S. Cl. CPC H01B 7/08; B60R 16/0207; H01B 7/0045

(57) ABSTRACT

There are provided a flat-shaped bundling member and a wire harness thereof. The flat-shaped bundling member has a sheet shape and bundles electric wires into a flat shape. The flat-shaped bundling member includes: a plurality of foldable structures configured to fold a sheet in a bellows shape; and an electric wire arrangement portion that is a flat surface portion and on which the electric wires are arranged in the flat shape when folded in the bellows shape by the plurality of foldable structures.

### CROSS-REFERENCE TO RELATED APPLICATIONS

This application is based on and claims priority under 35 USC 119 from Japanese Patent Application No. 2024-133911 filed on Aug. 9, 2024, the contents of which are incorporated herein by reference.

### TECHNICAL FIELD

The present disclosure relates to a flat-shaped bundling member and a wire harness.

### BACKGROUND ART

A wire harness in the related art is required to have a reduced height for a purpose of ensuring a space in a vehicle.

As an example, there is proposed a wire harness in which electric wires are flatly bundled in multiple stages by arranging electric wires side by side on a planar sheet material, arranging another sheet material thereon, and then arranging electric wires side by side (for example, see JP2019-204745A). There is also proposed a wire harness in which electric wires are arranged side by side in one or two stages on a sheet material, and at least a part of the arranged electric wires are covered from above and below by folding the sheet material (for example, see JP2021-157927A).

However, the sheet materials described in JP2019-204745A and JP2021-157927A are not good in workability as a flat-shaped bundling member that bundles a wire harness into a flat shape.

As an example, in a technique described in JP2019-204745A, placement of the sheet material, arrangement of the electric wires, and placement of the sheet material are sequentially performed, so that a wire harness is obtained, in which the electric wires flatly arranged in one stage are sandwiched from above and below to reduce a height. However, when the electric wires are provided in two or more stages, it is necessary to additionally perform the arrangement of the electric wires and the placement of the sheet material once or a plurality of times, resulting in a large number of steps. Therefore, it cannot be said that the wire harness described in JP2019-204745A can be manufactured with good workability.

Also in a technique described in JP2021-157927A, placement of the sheet material, placement of the electric wires, and a folding operation by an operator in an appropriate position are necessary. For this reason, when the operator performs folding in a wrong position, electric wires to be sandwiched from above and below may not be sandwiched, and electric wires preferably not sandwiched from above or below may be sandwiched. Therefore, the operator needs to pay attention to folding in a correct position, and it cannot be said that the wire harness described in JP2021-157927A can be manufactured with good workability.

### SUMMARY OF INVENTION

The present disclosure provides a flat-shaped bundling member and a wire harness that can further improve workability.

According to an illustrative aspect of the present disclosure, a flat-shaped bundling member that has a sheet shape and bundles electric wires into a flat shape includes: a plurality of foldable structures configured to fold a sheet in a bellows shape; and an electric wire arrangement portion that is a flat surface portion and on which the electric wires are arranged in the flat shape when folded in the bellows shape by the plurality of foldable structures.

According to another illustrative aspect of the present disclosure, a wire harness includes: the flat-shaped bundling member folded in the bellows shape as above; and the electric wires fixed on the electric wire arrangement portion of the flat-shaped bundling member. The protection portions on two end sides of the flat-shaped bundling member are coupled to each other.

### BRIEF DESCRIPTION OF DRAWINGS

FIG. 1 is a side view illustrating a schematic configuration of a wire harness and a flat-shaped bundling member according to a first embodiment;

FIG. 2 is a side view illustrating a part of a configuration of the wire harness illustrated in FIG. 1 in an unfolded state;

FIGS. 3A to 3D are enlarged sectional views illustrating details of the flat-shaped bundling member illustrated in FIGS. 1 and 2, in which FIG. 3A illustrates a first example,

FIG. 3B illustrates a second example, FIG. 3C illustrates a third example, and FIG. 3D illustrates a fourth example;

FIG. 4 is a first plan view illustrating details of a protection portion of the flat-shaped bundling member illustrated in FIGS. 1 and 2;

FIG. 5 is a second plan view illustrating details of the protection portion of the flat-shaped bundling member illustrated in FIGS. 1 and 2;

FIGS. 6A to 6C are process views illustrating a method for manufacturing the wire harness according to the first embodiment, in which FIG. 6A illustrates a first step, FIG. 6B illustrates a second step, and FIG. 6C illustrates a third step;

FIG. 7 is a table showing examples;

FIG. 8 is a side view illustrating a flat-shaped bundling member used in a wire harness according to a second embodiment;

FIG. 9 is a plan view illustrating a flat-shaped bundling member used in a wire harness according to a third embodiment;

FIG. 10 is a plan view illustrating an example of a bellows fold of a flat-shaped bundling member according to a first modification; and

FIG. 11 is a plan view illustrating an example of a bellows fold of a flat-shaped bundling member according to a second modification.

### DESCRIPTION OF EMBODIMENTS

Hereinafter, the present disclosure will be described with reference to preferred embodiments. The present disclosure is not limited to the embodiments to be described below, and can be appropriately changed without departing from the gist of the present disclosure. In the embodiments described below, there are sections in which illustration and description of a part of configurations are omitted, and it goes without saying that publicly known or well-known techniques are appropriately applied to details of omitted techniques within a range that does not cause contradiction with contents described below.

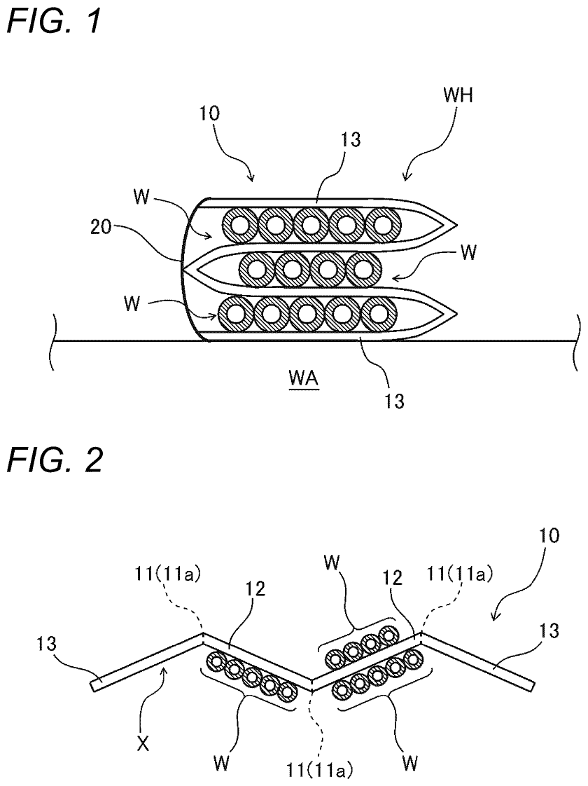

FIG. 1 is a side view illustrating a schematic configuration of a wire harness and a flat-shaped bundling member according to a first embodiment. A wire harness WH illustrated in FIG. 1 is provided on, for example, a wall surface WA of a vehicle, and is for bundling a plurality of electric wires W after the electric wires W are arranged side by side in a flat shape in multiple stages. The wire harness WH includes the plurality of electric wires W, a flat-shaped bundling member 10, and a coupling and fixing member 20.

The plurality of electric wires W are arranged in a flat shape, that is, along the wall surface WA in the example illustrated in FIG. 1. The plurality of electric wires W may be power supply lines, signal lines, and a combination thereof. The electric wires W are assumed to have any size using polyvinyl chloride (PVC) and polyolefin, but are not limited thereto, and may be twisted wires, coaxial wires, or optical fibers.

The flat-shaped bundling member 10 has a sheet shape, and, as a result of being folded in at least two positions, is folded in a bellows shape to bundle the electric wires W into a flat shape. FIG. 2 is a side view illustrating a part of a configuration of the wire harness WH illustrated in FIG. 1 in an unfolded state.

As illustrated in FIG. 2, the flat-shaped bundling member 10 includes a plurality of foldable structures 11, electric wire arrangement portions 12, and protection portions 13. The plurality of foldable structures 11 are for facilitating folding of a sheet in a bellows shape. That is, the foldable structure 11 may be a structure in which a force at a time of folding is reduced as compared with a part (for example, a position denoted by a reference sign X) without the foldable structure 11. In the first embodiment, the foldable structure 11 is implemented by a fold mark 11a formed by folding in advance in a mountain fold or a valley fold for folding in a bellows shape. Here, the mountain fold and the valley fold can be referred to as a convex fold and a concave fold, respectively.

The electric wire arrangement portion 12 is a portion that becomes a flat surface portion and on which the electric wires W are arranged in a flat shape when the flat-shaped bundling member 10 is folded in a bellows shape by the foldable structure 11. In the first embodiment, the foldable structure 11 is provided in three positions, and a portion sandwiched by the foldable structures 11 is the electric wire arrangement portion 12. In the first embodiment, a plurality of electric wire arrangement portions 12 have the same shape and area, and may also have different shapes or areas or different shapes and areas.

The protection portion 13 is a portion connected to the electric wire arrangement portion 12 on an outermost side when the flat-shaped bundling member 10 is folded by the foldable structure 11, and protects the electric wires W. As illustrated in FIG. 1, the protection portion 13 is located at an uppermost end or a lowermost end in a state of being installed in the vehicle. For this reason, in the first embodiment, the protection portion 13 protects the electric wires W from above and below.

In the first embodiment, the flat-shaped bundling member 10 includes the protection portion 13 on both end sides. However, the present disclosure is not limited thereto, and the flat-shaped bundling member 10 may include the protection portion 13 only on one side, or may not include the protection portion 13 when the flat-shaped bundling member 10 itself does not need to be protected, for example, when the flat-shaped bundling member 10 is covered with another exterior member.

The coupling and fixing member 20 illustrated in FIG. 1 couples the protection portions 13 on both end sides of the flat-shaped bundling member 10 to each other. In the first embodiment, the coupling and fixing member 20 is implemented by a resin tape having an adhesive surface on one surface and a resin on the other surface. The resin tape may be magic tape (registered trademark) or the like that is relatively easy to peel off. The coupling and fixing member 20 is not limited to the resin tape, and may be a needle member made of metal or resin attached by a tacker, or may be a bonding agent interposed between contact portions of the protection portions 13. The bonding agent is assumed to be one or a combination of two or more of natural rubber, styrene-isoprene-styrene block copolymer, and acrylic resin, but is not particularly limited thereto.

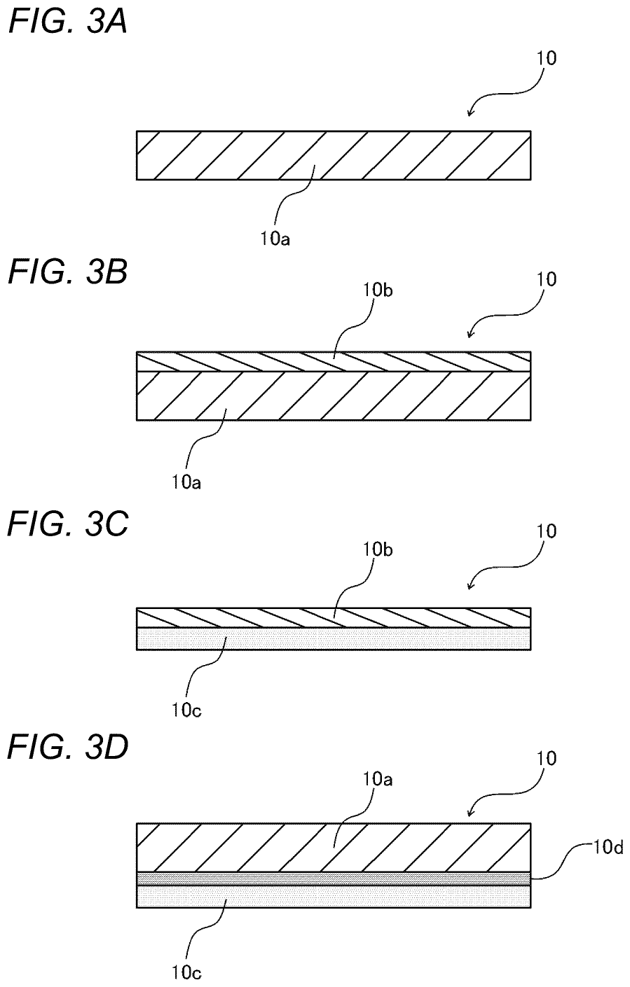

FIGS. 3A to 3D are enlarged cross-sectional views illustrating details of the flat-shaped bundling member 10 illustrated in FIGS. 1 and 2. The flat-shaped bundling member 10 may have various layer structures, and has one to three-layer structures in examples illustrated in FIGS. 3A to 3D.

First, as illustrated in FIG. 3A, the flat-shaped bundling member 10 has a single-layer structure including a base material layer 10a. The base material layer 10a may be, for example, a film of PVC, polyolefin, and polyethylene terephthalate (PET). The base material layer 10a may be a film of fluorine, polyimide, silicone, cellophane, nylon, and the like, and may be a mesh material or a cloth material. When the flat-shaped bundling member 10 has a single-layer structure including the base material layer 10a, the plurality of electric wires W are fixed to the flat-shaped bundling member 10 (base material layer 10a) by heat welding, ultrasonic welding, bonding, and pressure application by a clip or the like.

As illustrated in FIG. 3B, the flat-shaped bundling member 10 may have a two-layer structure including the base material layer 10a and a protective layer 10b. Here, the base material layer 10a and the protective layer 10b may be the same member or different members. When the base material layer 10a and the protective layer 10b are different members, the protective layer 10b is preferably implemented by a member having higher wear resistance and impact resistance than the substrate layer 10a. Similarly to the above, the plurality of electric wires W are fixed to the flat-shaped bundling member 10 (base material layer 10a) by heat welding, ultrasonic welding, bonding, and pressure application by a clip or the like.

As illustrated in FIG. 3C, the flat-shaped bundling member 10 may have a two-layer structure including the protective layer 10b and an adhesive layer 10c. Since the flat-shaped bundling member 10 includes the adhesive layer 10c, the plurality of electric wires W can be fixed on the electric wire arrangement portion 12 (see FIG. 2) without requiring thermal welding or the like.

As illustrated in FIG. 3D, the flat-shaped bundling member 10 may have a three-layer structure including the base material layer 10a, the adhesive layer 10c, and an undercoat layer 10d interposed therebetween. Similarly to the above, since the flat-shaped bundling member 10 includes the adhesive layer 10c, the plurality of wires W can be fixed on the electric wire arrangement portion 12 without requiring thermal welding or the like. Since the flat-shaped bundling member 10 includes the undercoat layer 10d, it is possible to prevent a substance in the adhesive layer 10c from migrating to the base material layer 10a and making the adhesive layer 10c difficult to exert an adhesive force, and to prevent the base material layer 10a from being altered. Since the flat-shaped bundling member 10 includes the undercoat layer 10d, sufficient adhesion can be obtained even when compatibility between the base material layer 10a and the adhesive layer 10c is poor.

The flat-shaped bundling member 10 is not limited to that described above. For example, in the flat-shaped bundling member 10, the above-described components may be combined with each other such that the electric wire arrangement portion 12 has the configuration of FIG. 3C and the protection portion 13 (see FIG. 2) has the configuration of FIG. 3B if possible. Each of the layers 10a to 10d may include two or more layers.

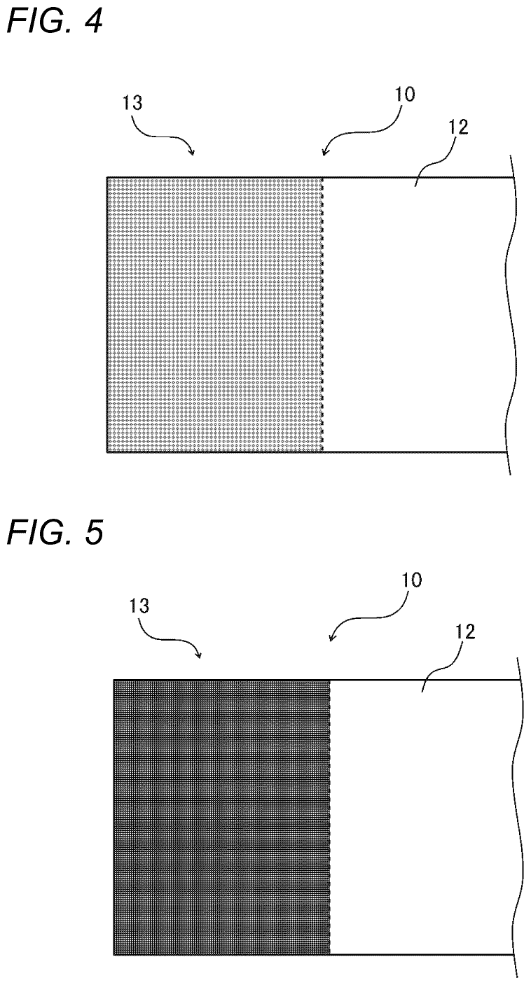

FIGS. 4 and 5 are plan views illustrating details of the protection portion 13 of the flat-shaped bundling member 10 illustrated in FIGS. 1 and 2. As illustrated in FIG. 4, the protection portion 13 is preferably embossed. The embossing can be performed by, for example, pressing. In this manner, even when the protection portion 13 wears, convex portions wear first, and concave portions wear after the wear of the convex portions. Therefore, the protection portion 13 subjected to embossing has improved wear resistance as compared with the planar protection portion 13. Since the protection portion 13 has irregularities, protection performance against impact (dispersion of impact) and puncture (formation of gaps) from an upper face can also be improved.

As illustrated in FIG. 5, the protection portion 13 preferably has a mesh structure. Here, the protection portion 13 may have a mesh structure as a result of the flat-shaped bundling member 10 having a single-layer structure including the base material layer 10a having a mesh structure. In the flat-shaped bundling member 10, the protection portion 13 may also have a mesh structure by, giving the base material layer 10a having a mesh structure, providing the adhesive layer 10c only on the electric wire arrangement portion 12 or providing the adhesive layer 10c on the entire base material layer 10a. Further, in the flat-shaped bundling member 10, the protection portion 13 may be formed by adding a mesh structure as an additional layer to two end portions of a two-layer structure including the base material layer 10a and the adhesive layer 10c.

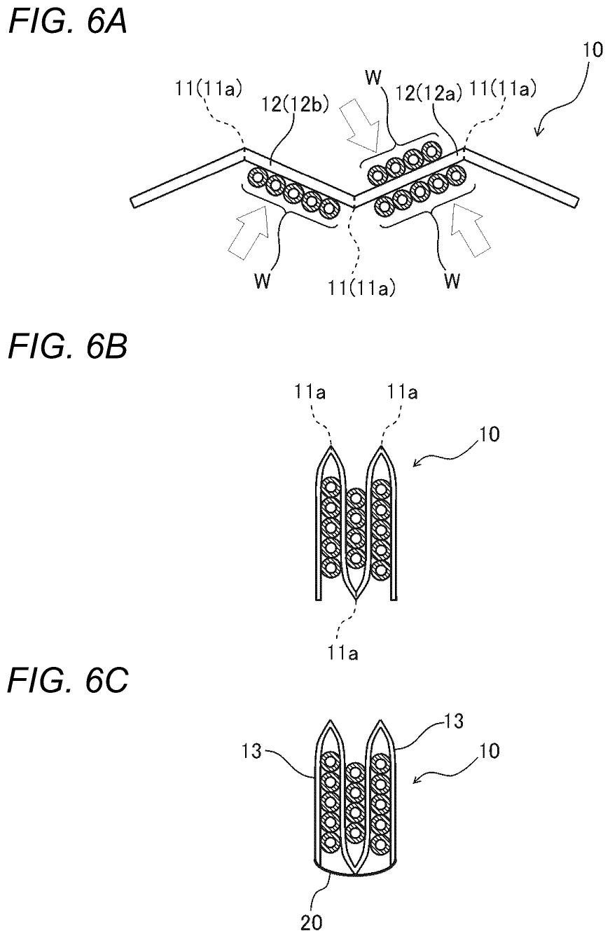

Next, a method for manufacturing the wire harness WH according to the first embodiment will be described. FIGS. 6A to 6C are process views illustrating the method for manufacturing the wire harness WH according to the first embodiment, in which FIG. 6A illustrates a first step, FIG. 6B illustrates a second step, and FIG. 6C illustrates a third step.

First, the flat-shaped bundling member 10 as illustrated in FIG. 6A is prepared. In the flat-shaped bundling member 10, as illustrated in FIG. 6A, the foldable structures 11 are formed by the fold marks 11a obtained by folding the flat-shaped bundling member 10 in a mountain fold or a valley fold in advance.

Next, in a first step, a plurality of electric wires W are fixed on the electric wire arrangement portions 12. At this time, the electric wires W may be fixed on two surfaces of the electric wire arrangement portion 12 as indicated by a reference numeral 12a, and may also be fixed on one surface of the electric wire arrangement portion 12 as indicated by a reference numeral 12b. Depending on specifications of the wire harness WH, there may be an electric wire arrangement portion 12 in which no electric wire W is arranged.

Thereafter, as illustrated in FIG. 6B, the flat-shaped bundling member 10 is folded in a bellows shape. At this time, the flat-shaped bundling member 10 is easily folded in a bellows shape in predetermined positions by a plurality of foldable structures 11.

Next, as illustrated in FIG. 6C, in the flat-shaped bundling member 10, the protection portions 13 are coupled to each other by the coupling and fixing member 20. The coupling is performed by adhering a resin tape, a tacker, a bonding agent, and the like.

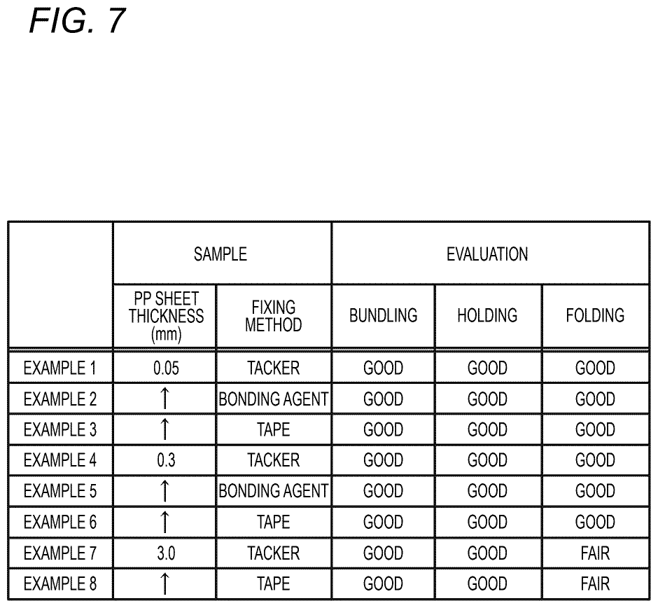

FIG. 7 is a table showing examples. As shown in FIG. 7, in Example 1, a flat-shaped bundling member had a single-layer structure including a base material layer (thickness: 0.05 mm) made of PP. Electric wires included one insulated electric wire of 0.13 sq, one insulated electric wire of 0.35 sq, one twisted wire of 0.35 sq, and one insulated electric wire of 0.5 sq. The electric wires were fixed to an electric wire arrangement portion by a tacker.

Example 2 was the same as Example 1 except that the electric wires were fixed with a bonding agent. The bonding agent was Bond G17 (manufactured by Konishi Co., Ltd.).

Example 3 was the same as Example 1 except that the electric wires were fixed with a tape. The tape was a double-sided tape No. 7021 (thickness: 0.05 mm) manufactured by Teraoka Seisakusho Co., Ltd.

Example 4 was the same as Example 1 except that the thickness of the base material layer was 0.3 mm. Example 5 was the same as Example 4 except that the electric wires were fixed with a bonding agent. The bonding agent was the same as that in Example 2. Example 6 was the same as Example 4 except that the electric wires were fixed with a tape. The tape was the same as that in Example 3.

Example 7 was the same as Example 1 except that the thickness of the base material layer was 3.0 mm. Example 8 was the same as Example 7 except that the electric wires were fixed with a tape. The tape was the same as that in Example 3.

For Examples 1 to 8 as described above, the applicant of the present application conducted evaluations of bundling, holding, and folding. Regarding the bundling, presence and absence of electric wire protrusion due to an increase in a length of electric wires sandwiched by a flat-shaped bundling member as a result of insufficient adhesion of the electric wires to the flat-shaped bundling member and separation of a part of the electric wires from the flat-shaped bundling member was evaluated. A case where there was no protrusion was evaluated as “good”. Regarding the holding, a case where no electric wires were dropped for 24 hours in a state of being fixed to a horizontally arranged flat-shaped bundling member from below was evaluated as “good”. In terms of the folding, as illustrated in FIG. 6B, it was evaluated whether a flat-shaped bundling member was folded in a bellows shape in intended positions (positions of foldable structures) when a force was applied from two ends by human force. A case of being folded in intended positions was evaluated as “good”, and a case of being folded in intended positions by making a cut in the positions of the foldable structures was evaluated as “fair”.

As a result, in all of Examples 1 to 8, bundling and holding were “good”. In Examples 1 to 6, folding was also “good”. In Examples 7, 8, folding was “fair”, but there was no problem in a product since it could be handled by cutting. Cutting is also one of the foldable structures. However, the foldable structures by cutting are appropriate when the flat-shaped bundling member has a large thickness; when the flat-shaped bundling member has a small thickness, a fold mark or a member described later is preferable since the flat-shaped bundling member may be torn.

In this manner, according to the flat-shaped bundling member 10 in the first embodiment, a plurality of foldable structures 11 for folding a sheet in a bellows shape are provided. Accordingly, the sheet can be folded by the foldable structures 11 after the electric wires W are arranged on the electric wire arrangement portions 12. This reduces a probability that the sheet is folded in a wrong position. Further, the folding step may be performed after the electric wires W are arranged on the sheet, and the number of steps can be reduced even when the electric wires W are arranged in multiple stages. Therefore, it is possible to provide the flat-shaped bundling member 10 that can further improve workability.

Further, the protection portions 13 that are connected to the electric wire arrangement portions 12 on the outermost side and protect the electric wires W are provided. Accordingly, the electric wires W can be not only bundled in a flat shape but also protected and used as an exterior material.

Further, the plurality of foldable structures 11 have the fold marks 11a formed by folding in a mountain fold or a valley fold in advance for folding in a bellows shape. For this reason, the fold marks 11a may be formed in advance on the sheet in accordance with the number and size of the electric wires W to be bundled into a flat shape, so that the foldable structures 11 can be easily implemented, and various flat-shaped bundling modes can be handled.

Further, according to the wire harness WH in the first embodiment, the electric wires W are fixed on the electric wire arrangement portion 12, and then the protection portions 13 on two end sides are coupled to each other. For this reason, the wire harness WH can be flatly bundled and prevented from being unfolded.

Next, a second embodiment according to the present disclosure will be described. The wire harness WH according to the second embodiment is similar to that of the first embodiment, and a part of a configuration thereof is different. Hereinafter, only differences from the first embodiment will be described. In the second embodiment, the same or similar elements as those in the first embodiment are denoted by the same reference numerals.

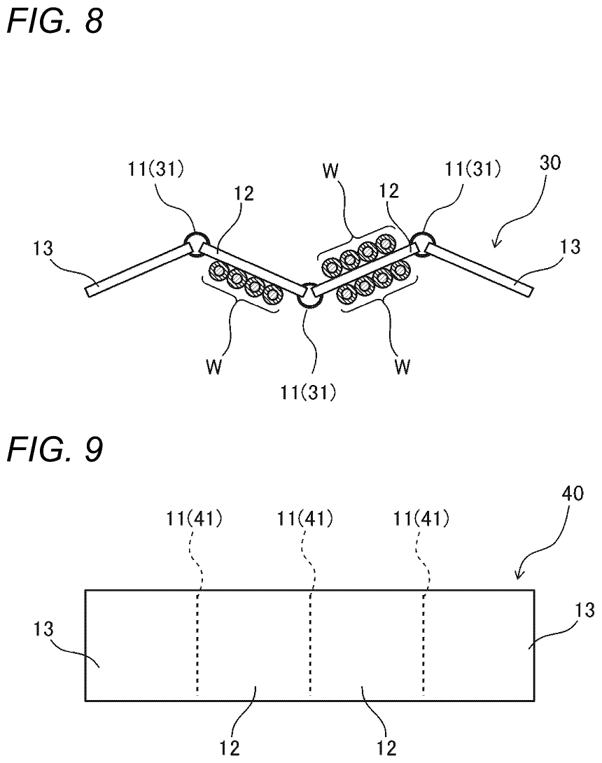

FIG. 8 is a side view illustrating a flat-shaped bundling member used in the wire harness WH according to the second embodiment. As illustrated in FIG. 8, in a flat-shaped bundling member 30 used in the wire harness WH according to the second embodiment, the electric wire arrangement portion 12 and the protection portion 13 are formed apart from each other. In the flat-shaped bundling member 30 according to the second embodiment, the electric wire arrangement portion 12 and the protection portion 13 are formed with small holes, and a ring member 31 is provided as the foldable structure 11. The ring member 31 connects the electric wire arrangement portion 12 and the protection portion 13 to each other through the small holes formed in the electric wire arrangement portion 12 and the protection portion 13.

Here, in the flat-shaped bundling member 30 according to the second embodiment, no sheet is folded by the fold mark 11a. For this reason, the electric wire arrangement portion 12 and the protection portion 13 can be easily formed as separate members. As a result, the electric wire arrangement portion 12 can be a member to which the electric wires are easily fixed, and the protection portion 13 can be a member having high wear resistance.

Next, a method for manufacturing the wire harness WH according to the second embodiment will be described. In the second embodiment, first, separate sheets corresponding to the electric wire arrangement portions 12 and the protection portions 13 are prepared. The operator opens small holes in these sheets and couples the electric wire arrangement portions 12 and the protection portions 13 with the ring members 31 through the small holes. Thereafter, as in the first embodiment, the electric wires W are fixed on the electric wire arrangement portions 12 in a first step. Next, in a second step, the flat-shaped bundling member 30 is folded in a bellows shape. At this time, the flat-shaped bundling member 30 is folded by ring shapes of the ring members 31 that are the foldable structures 11. Thereafter, in the flat-shaped bundling member 30, the protection portions 13 are couple to each other by a tacker or the like.

In this manner, according to the flat-shaped bundling member 30 and the wire harness WH in the second embodiment, similarly to the first embodiment, it is possible to provide the flat-shaped bundling member 30 that can further improve workability and use the flat-shaped bundling member 30 as an exterior material. Further, the wire harness WH can be flatly bundled and prevented from being unfolded.

According to the second embodiment, the plurality of foldable structures 11 include the ring members 31 that connect the electric wire arrangement portions 12 and the protection portions 13 formed apart from each other. By implementing the foldable structure 11 with the ring member 31, the electric wire arrangement portion 12 and the protection portion 13 can be formed apart from each other, and it is not necessary to fold the sheet itself. Accordingly, for example, the electric wire arrangement portion 12 can be a member to which electric wires are easily fixed, and the protection portion 13 can be a member having high wear resistance. This makes it possible to provide a more appropriate bundling structure or protection structure.

Next, a third embodiment according to the present disclosure will be described. The wire harness WH according to the third embodiment is similar to that of the first embodiment, and a part of a configuration thereof is different. Hereinafter, differences from the first embodiment will be described. In the third embodiment, the same or similar elements as those of the first embodiment are denoted by the same reference numerals.

FIG. 9 is a plan view illustrating a flat-shaped bundling member used in the wire harness WH according to the third embodiment. As illustrated in FIG. 9, in a flat-shaped bundling member 40 used in the wire harness WH according to the third embodiment, a linear body 41 such as a linear wire is provided as the foldable structure 11 in advance between the electric wire arrangement portions 12 and between the electric wire arrangement portion 12 and the protection portion 13. The linear body 41 is preferably harder than the electric wire arrangement portion 12 and the protection portion 13. In the third embodiment, the linear body 41 is embedded inside the flat-shaped bundling member 40, and may also be provided on a surface.

Here, in the flat-shaped bundling member 40 according to the third embodiment, it is not necessary to attach the ring member 31. The flat-shaped bundling member 40 does not need to be provided with the fold mark 11a in advance, either, and can be stored in a planar state.

Next, a method for manufacturing the wire harness WH according to the third embodiment will be described. In the third embodiment, first, as in the first embodiment, the electric wires W are fixed on the electric wire arrangement portion 12 in a first step. Next, in a second step, the flat-shaped bundling member 40 is folded in a bellows shape. At this time, since the flat-shaped bundling member 40 includes the linear body 41, the flat-shaped bundling member 40 easily folds starting from the linear body 41, and is folded near each linear body 41. The flat-shaped bundling member 40 may also fold in advance near the linear body 41 in a mountain fold or a valley fold for folding in a bellows shape. Thereafter, in the flat-shaped bundling member 40, the protection portions 13 are coupled to each other by a tacker or the like.

In this manner, according to the flat-shaped bundling member 40 and the wire harness WH in the third embodiment, similarly to the first embodiment, it is possible to provide the flat-shaped bundling member 40 that can further improve workability and use the flat-shaped bundling member 40 as an exterior material. Further, the wire harness WH can be flatly bundled and prevented from being unfolded.

According to the third embodiment, the foldable structure 11 includes the linear body 41 provided in a linear shape between the electric wire arrangement portions 12 or between the electric wire arrangement portion 12 and the protection portion 13. Accordingly, the foldable structure 11 can easily fold starting from the linear body 41, and the foldable structure 11 can be easily implemented.

Although the present disclosure has been described above based on the embodiments, the present disclosure is not limited to the above embodiments, modifications may be made without departing from the gist of the present disclosure, and techniques according to the embodiments and publicly known or well-known techniques may be combined if possible.

FIG. 10 is a plan view illustrating an example of a bellows fold of a flat-shaped bundling member according to a first modification. As illustrated in FIG. 10, a flat-shaped bundling member 50 according to the first modification may be, for example, longer than those described above, and may fold in a bellows shape in a direction intersecting both a longitudinal direction and a lateral direction. The flat-shaped bundling member 50 may have a W-shape in a plan view as a result of the bellows shaped folding. That is, the flat-shaped bundling member 50 may be folded in a bellows shape when viewed from a specific direction (for example, a direction of an arrow Y in FIG. 10).

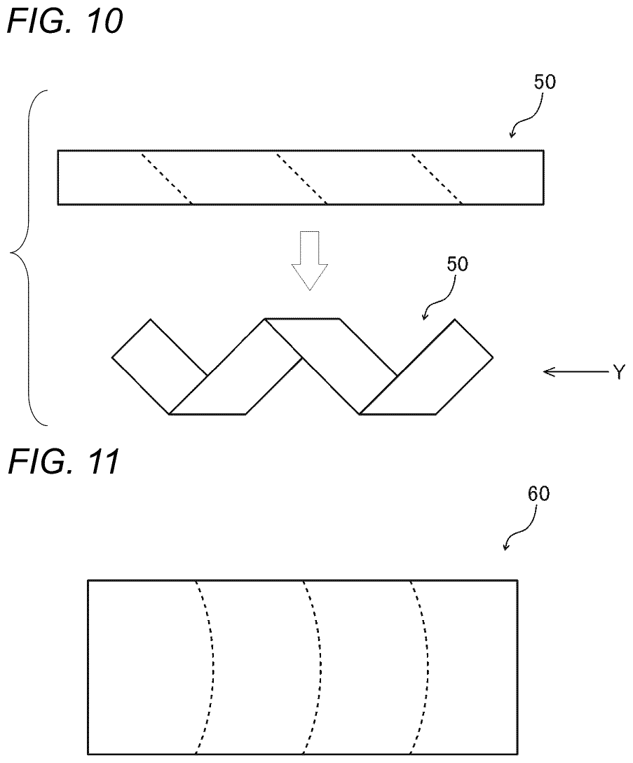

FIG. 11 is a plan view illustrating an example of a bellows fold of a flat-shaped bundling member according to a second modification. As illustrated in FIG. 11, a flat-shaped bundling member 60 according to the second modification may have, for example, a curved folding position and may be folded in a bellows shape in a curved shape. When the folded position is a curved line, wrinkles are likely to occur in a part of the flat-shaped bundling member 60. For this reason, a cut may be formed in the part of the flat-shaped bundling member 60 to prevent the wrinkles.

In the above embodiments, the wire harness WH may be wound a plurality of turns as a whole with a resin tape after the protection portions 13 are coupled by the coupling and fixing member 20.

According to a first aspect of the present disclosure, a flat-shaped bundling member (10, 30, 40, 50, 60) that has a sheet shape and bundles electric wires (W) into a flat shape includes: a plurality of foldable structures (11) configured to fold a sheet in a bellows shape; and an electric wire arrangement portion (1) that is a flat surface portion and on which the electric wires (W) are arranged in the flat shape when folded in the bellows shape by the plurality of foldable structures (11).

According to a second aspect of the present disclosure, the flat-shaped bundling member (10, 30, 40, 50, 60) according to the first aspect further includes: a protection portion (13) that is connected to the electric wire arrangement portion (12) on an outermost side and protects the electric wires (W) when the flat-shaped bundling member is folded in the bellows shape by the plurality of foldable structures (11).

According to a third aspect of the present disclosure, in the flat-shaped bundling member (10, 50, 60) according to the second aspect, the plurality of foldable structures (11) each have a fold mark (11a) formed by folding in advance in a convex fold or a concave fold for folding in the bellows shape.

According to a fourth aspect of the present disclosure, in the flat-shaped bundling member (30) according to the second aspect, the plurality of foldable structures (11) each include a ring member (31) that connects the electric wire arrangement portion (12) and the protection portion (13) formed apart from each other or the electric wire arrangement portions (12) formed apart from each other.

According to a fifth aspect of the present disclosure, in the flat-shaped bundling member (40) according to the second aspect, the plurality of foldable structures (11) each include a linear body (41) provided in a linear shape between the electric wire arrangement portion (12) and the protection portion (13) and between the adjacent electric wire arrangement portions (12, 12).

According to a sixth aspect of the present disclosure, a wire harness includes: the flat-shaped bundling member (10, 30, 40, 50, 60) folded in the bellows shape according to the second aspect; and the electric wires (W) fixed on the electric wire arrangement portion (12) of the flat-shaped bundling member, in which the protection portions (13, 13) on two end sides of the flat-shaped bundling member are coupled to each other.

According to the present disclosure, it is possible to provide a flat-shaped bundling member and a wire harness that can further improve workability.

What is claimed is:

1. A flat-shaped bundling member that has a sheet shape and bundles electric wires into a flat shape, the flat-shaped bundling member comprising:
a plurality of foldable structures configured to fold a sheet in a bellows shape; and
an electric wire arrangement portion that is a flat surface portion and on which the electric wires are arranged in the flat shape when folded in the bellows shape by the plurality of foldable structures.

2. The flat-shaped bundling member according to claim 1, further comprising:
a protection portion that is connected to the electric wire arrangement portion on an outermost side and protects the electric wires when the flat-shaped bundling member is folded in the bellows shape by the plurality of foldable structures.

3. The flat-shaped bundling member according to claim 2, wherein
the plurality of foldable structures each have a fold mark formed by folding in advance in a convex fold or a concave fold for folding in the bellows shape.

4. The flat-shaped bundling member according to claim 2, wherein
the plurality of foldable structures each include a ring member that connects the electric wire arrangement portion and the protection portion formed apart from each other or the electric wire arrangement portions formed apart from each other.

5. The flat-shaped bundling member according to claim 2, wherein
the plurality of foldable structures each include a linear body provided in a linear shape between the electric wire arrangement portion and the protection portion and between the adjacent electric wire arrangement portions.

6. A wire harness comprising:
the flat-shaped bundling member folded in the bellows shape according to claim 2; and
the electric wires fixed on the electric wire arrangement portion of the flat-shaped bundling member, wherein
the protection portions on two end sides of the flat-shaped bundling member are coupled to each other.
